(19) United States
(12) Patent Application Publication
(10) Pub. No.: US 2025/0377748 A1
(43) Pub. Date: Dec. 11, 2025

(54) ELECTRONIC DEVICE, PROGRAM, AND INPUT SYSTEM

(71) Applicant: Wacom Co., Ltd., Saitama (JP)

(72) Inventors: Tsukasa NOMI, Saitama (JP); Hideki FUJIMAKI, Saitama (JP)

(21) Appl. No.: 19/200,011

(22) Filed: May 6, 2025

(30) Foreign Application Priority Data
Jun. 5, 2024 (JP) 2024-091373

(51) Int. Cl. G06F 3/041; G06F 3/0354

(52) U.S. Cl. CPC G06F 3/04162; G06F 3/03545; G06F 3/04166; G06F 2203/04104; G06F 2203/04106

(57) ABSTRACT

An electronic device includes a display panel that displays a displayed object, and a pen sensor provided to overlap a display area of the display panel and configured to detect a position and a posture of the electronic pen. The electronic device includes a calculation processor that calculates a rotation angle of the displayed object displayed on the display panel on a basis of detection information indicating a state related to the posture of the electronic pen detected by the pen sensor and on a basis of reference information indicating a reference state related to the posture of the electronic pen. The electronic device includes a display controller that controls display of the display panel to rotate the displayed object by the rotation angle calculated by the calculation processor.

### BACKGROUND

### Technical Field

The present disclosure relates to an electronic device, a program, and an input system, and particularly, to an electronic device, a program, and an input system that receive a position indicated by an electronic pen for display on a screen.

### Description of the Related Art

Conventionally, an electronic device is known, which includes a touch panel that detects a position indicated by a finger, an electronic pen, or the like, and a display unit that displays a screen according to what is detected by the touch panel. For the electronic device, there is a known technique in which a gyro sensor is installed in the electronic device and a displayed object is rotated according to a posture of the electronic device detected by the gyro sensor.

A spatial position indication system (electronic device) is disclosed in Japanese Patent Laid-open No. 2019-46458. The spatial position indication system includes an indicated position detection unit that detects a position indicated by an electronic pen to a sensor, and a spatial position detection unit that detects an operation of the electronic pen in a spatial area.

### BRIEF SUMMARY

In some cases, the electronic device has a function of changing the display angle of the screen of the electronic device when, for example, the direction of the electronic device relative to the user is changed. However, in the technique described in Japanese Patent Laid-open No. 2019-46458, when the direction of the electronic device, which is horizontally placed and used, is changed, as long as the horizontal state is maintained, an automatic rotation function is not performed for the direction of the display. Therefore, to perform the automatic rotation function in the technique described in Japanese Patent Laid-open No. 2019-46458, the electronic device needs to be temporarily held in a manner so as to be tilted relative to the horizontal direction, which diminishes usability of the electronic device.

The present disclosure provides a solution to the problem according to an aspect, and provides an electronic device, a program, and an input system that can rotate a displayed object without impairing usability of the electronic device.

According to a first aspect of the present disclosure, an electronic device includes a display panel that displays a displayed object, a pen sensor provided to overlap a display area of the display panel and configured to detect a position and a posture (orientation) of the electronic pen, and a calculation processor that calculates a rotation angle of the displayed object on the display panel on the basis of detection information indicating a state related to the posture of the electronic pen detected by the pen sensor and on the basis of reference information indicating a reference state related to the posture of the electronic pen. The electronic device also includes a display controller that controls display of the display panel to rotate the displayed object by the rotation angle calculated by the calculation processor.

According to a second aspect, the pen sensor of the electronic device is a touch sensor that further detects a position of a user contact part of the user holding the electronic pen. Each of the detection information and the reference information includes a pen coordinate value indicating the position of the electronic pen, a posture value indicating the posture of the electronic pen, and a contact part coordinate value indicating the position of the user contact part.

According to a third aspect, the electronic device additionally includes a touch sensor provided to overlap the display area and the pen sensor and configured to detect a position of a user contact part of the user holding the electronic pen. Each of the detection information and the reference information includes a pen coordinate value indicating the position of the electronic pen, a posture value indicating the posture of the electronic pen, and a contact part coordinate value indicating the position of the user contact part.

According to a fourth aspect, the calculation processor, when the detection information satisfies a predetermined condition with respect to the reference information, calculates, as the rotation angle, an angle in a direction associated with the predetermined condition relative to a reference direction set in advance on the display panel.

According to a fifth aspect, the electronic pen is an active pen capable of storing user information, which relates to a user and which includes the predetermined condition. The pen sensor receives the user information transmitted from the electronic pen, and the calculation processor calculates the rotation angle according to the predetermined condition indicated in the user information received by the pen sensor.

According to a sixth aspect, the electronic device further includes a storage unit that stores, for each user, user information including a log-in status of the user and the predetermined condition associated with the user. The calculation processor calculates the rotation angle according to the predetermined condition indicated in the user information associated with the currently logged-in user.

According to a seventh aspect, the electronic device further includes an acquisition unit that acquires, from an external server, user information including a log-in status of the user and the predetermined condition associated with the user. The calculation processor calculates the rotation angle according to the user information associated with the currently logged-in user.

According to an eighth aspect, the displayed object includes all objects displayed on the display panel.

According to a ninth aspect, the electronic device further includes a storage unit that stores content to be displayed on the display panel. The calculation processor calculates the rotation angle of the content, which is displayed on the display panel as the displayed object.

According to a tenth aspect, the electronic device further includes a storage unit that stores content to be displayed on the display panel. The calculation processor calculates the rotation angle of a predetermined area included in the content, which is displayed on the display panel as the displayed object.

According to an eleventh aspect of the present disclosure, a program is provided, which causes a computer to function as a calculation processor and a display controller of an electronic device. The electronic device includes a display panel that displays a displayed object and a pen sensor provided to overlap a display area of the display panel and configured to detect a position and a posture of the electronic pen. The calculation processor is configured to calculate a rotation angle of the displayed object on the display panel on the basis of detection information indicating a state related to the posture of the electronic pen detected by the electronic pen and on the basis of reference information indicating a reference state related to the posture of the electronic pen. The electronic device includes a display controller that controls display of the display panel to rotate the displayed object by the rotation angle calculated by the calculation processor.

According to a twelfth aspect of the present disclosure, an input system is provided, which includes an electronic pen and an electronic device. The electronic pen indicates a position to a display panel configured to display a displayed object. The electronic device includes a pen sensor provided to overlap a display area of the display panel and configured to detect a position and a posture of the electronic pen, and a calculation processor that calculates a rotation angle of the displayed object on the display panel on the basis of detection information indicating a state related to the posture of the electronic pen detected by the pen sensor and on the basis of reference information indicating a reference state related to the posture of the electronic pen. The electronic device includes a display controller that controls display of the display panel to rotate the displayed object by the rotation angle calculated by the calculation processor.

According to the present disclosure, the electronic device can rotate and display the displayed object without impairing usability of the electronic device.

### BRIEF DESCRIPTION OF THE SEVERAL VIEWS OF THE DRAWINGS

FIG. 1 depicts an example of an input system;

FIG. 2 depicts an example of specific configurations of an electronic device and an electronic pen;

FIG. 3 depicts an example of functional components of a host processor of the electronic device;

FIG. 4A depicts a posture of the electronic pen relative to a display panel of the electronic device;

FIG. 4B depicts a position of the electronic pen and a position of a contact part on the display panel;

FIG. 4C is a cross-sectional view along line IV-IV of the electronic device illustrated in FIG. 4A;

FIG. 5A depicts a first example of the electronic device displaying displayed objects before rotation;

FIG. 5B depicts a first example of the electronic device displaying the displayed objects after the rotation;

FIG. 5C depicts a second example of the electronic device displaying displayed objects before the rotation;

FIG. 5D depicts a second example of the electronic device displaying the displayed objects after the rotation;

FIG. 6 is a flow chart illustrating an example of a processing flow executed by the electronic device;

FIG. 7 is a schematic view illustrating a configuration of a communication system including the electronic devices and a server; and

FIG. 8 depicts another example of a configurations of the electronic device and the electronic pen.

### DETAILED DESCRIPTION

Embodiments of the present disclosure (hereinafter, referred to as the “present embodiment”) will be described with reference to the attached drawings. To facilitate understanding of the description, the same reference signs are used as much as possible for the same constituent elements and steps in the drawings, and their description will not be repeated.

### Overall Configuration

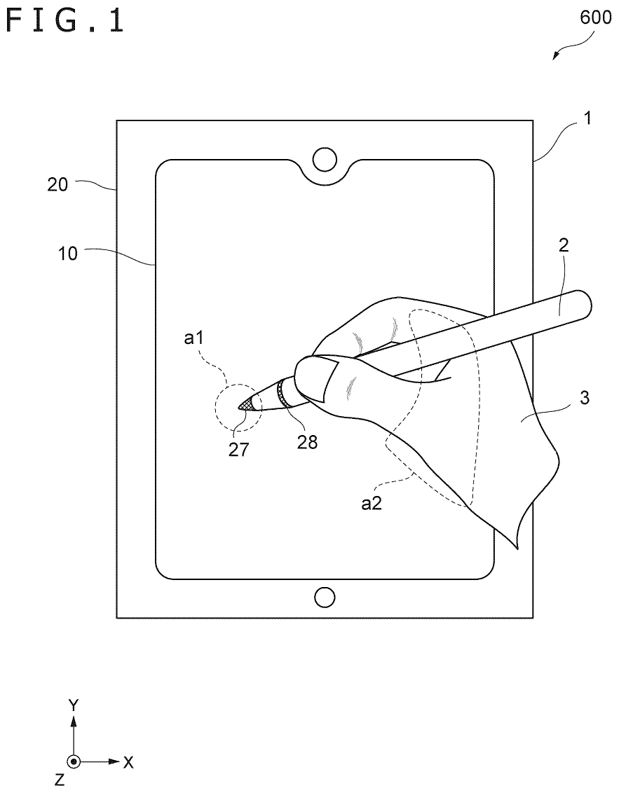

FIG. 1 depicts an example of an input system 600. As illustrated in FIG. 1, the input system 600 includes, for example, an electronic device 1 and an electronic pen 2. The electronic device 1 is a computer possessed by a user, and examples of the electronic device 1 include a tablet, a smartphone, and a personal computer. The electronic device 1 includes a display panel 10 and a housing 20. The user can move a pen tip of the electronic pen 2, which is a pen-shaped pointing device, or a finger of the user while pressing the pen tip or the finger against the display panel 10 included in the electronic device 1, to draw a picture or a character on the display panel 10 of the electronic device 1. The electronic pen 2 may be, for example, an active touch pen, or may be a non-active touch pen. Note that, in the present embodiment, when the display panel 10 of the electronic device 1 is viewed from the front, the upper direction is defined as a Y-axis direction, the direction to the right is defined as an X-axis direction, and the forward direction is defined as a Z-axis direction.

The electronic device 1 detects a position and a posture of the electronic pen 2 on the display panel 10 and detects a position of a contact part 3 of the human body, such as the user's palm, finger, wrist, arm, and elbow when the user is holding the electronic pen 2 and, based on the detection results, executes various types of information processing. Examples of the various types of information processing include a process of generating digital ink, a display control process of displaying a displayed object on the display panel 10, and a process of calculating a rotation angle of the displayed object. Note that the area in which a position of the electronic pen 2 is detected on the display panel 10 by the electronic device 1 will be defined as area a1, and the area in which a position of the contact part 3 of the human body is detected on the display panel 10 by the electronic device 1 will be defined as area a2.

### Circuit Configuration

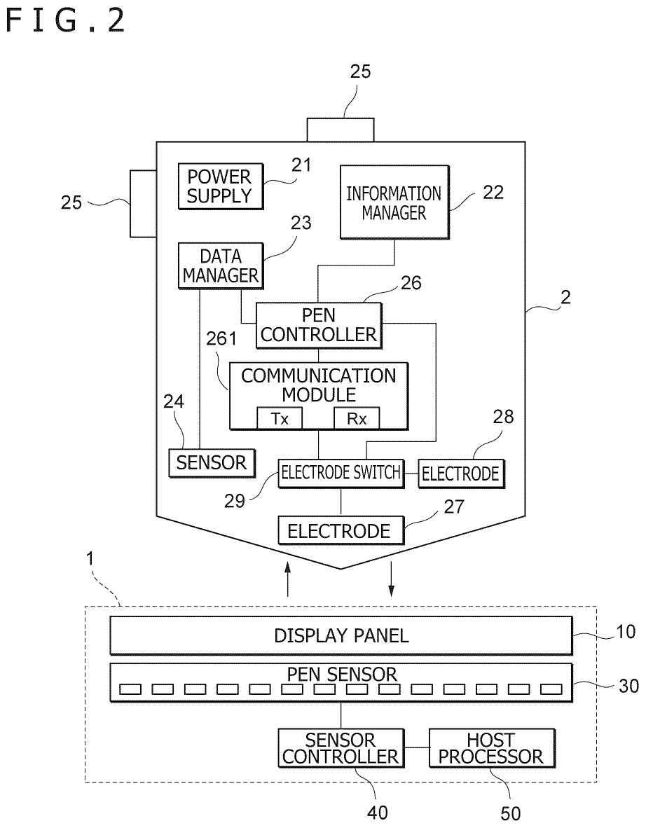

Specific configurations of the electronic device 1 and the electronic pen 2 will be described with reference to FIG. 2. FIG. 2 depicts an example of specific configurations of the electronic device 1 and the electronic pen 2. As illustrated in FIG. 2, the electronic device 1 includes, for example, the display panel 10, a pen sensor 30, a sensor controller 40, and a host processor 50. Although not illustrated, the electronic device 1 also includes a memory, a communication module, and the like. Note that, in FIG. 2, the electronic pen 2 is an active capacitance type (AES) stylus.

The pen sensor 30 is, for example, a capacitance sensor including a plurality of detection electrodes arranged in a planar shape. The pen sensor 30 includes, for example, a plurality of X-line electrodes for detecting the position on the X-axis of the sensor coordinate system and a plurality of Y-line electrodes for detecting the position on the Y-axis. The X-line electrodes and the Y-line electrodes may be formed of a transparent conductive material containing Indium Tin Oxide (ITO) or may be formed of a wire mesh sensor. Note that the pen sensor 30 may be, instead of the mutual capacitance sensor described above, a self-capacitance sensor including block-shaped electrodes arranged in a two-dimensional grid. Although the pen sensor 30 is a capacitance sensor in the present embodiment, the pen sensor 30 is not limited to this, and the pen sensor 30 may be formed of, for example, a loop coil antenna used in the electro magnetic resonance (EMR) type system.

The sensor controller 40 controls the operation of the position detection of the electronic pen 2 and the contact part 3 of the user, etc., performed by the pen sensor 30. The sensor controller 40 also controls the reception and the transmission operation of the pen sensor 30 to thereby execute two-way communication with the electronic pen 2. The sensor controller 40 also communicates with the host processor 50.

Specifically, the sensor controller 40 processes handwritten input data from the pen sensor 30 to detect, as a coordinate value, the position on the pen sensor 30 indicated by the electronic pen 2 and to detect, as a posture value, the posture of the electronic pen 2 relative to the pen sensor 30. The sensor controller 40 also processes handwritten input data from the contact part 3 of the user to detect the position on the pen sensor 30 indicated by the contact part 3 as a contact part coordinate value. The sensor controller 40 transfers the detected coordinate value, posture value, and contact part coordinate value as detection information to the host processor 50.

The host processor 50 communicates with the sensor controller 40 and executes various applications or functions. The host processor 50 receives the detection information from the sensor controller 40 and executes applications or functions on the basis of the received detection information to control the display of the display panel 10. The host processor 50 includes, for example, a communication apparatus, a storage apparatus, a central processing unit (CPU), and a memory. The host processor 50 functions as various functional components, to be described later, when the CPU executes predetermined programs stored in the memory, the storage apparatus, and the like. The communication apparatus includes a communication interface or the like for communicating with an external apparatus. The storage apparatus includes a hard disk or the like. The storage apparatus stores various programs and various types of information necessary for executing the processes of the host processor 50 and stores information of processing results.

The display panel 10 can display displayed objects, such as texts, images, and movies. Specifically, the display panel 10 can display monochrome images or color images and includes, for example, a liquid crystal panel, an organic electro-luminescence (EL) panel, electronic paper, or a quantum dot panel. The liquid crystal panel may be any one of a backlight type, a mini light emitting diode (LED) type, and a micro LED type. The display panel 10 displays the displayed objects according to the control of the host processor 50 in response to the detection of the electronic pen 2 or the contact part 3 by the pen sensor 30. The display panel 10 is provided above the pen sensor 30 (in the Z-axis direction) as illustrated in FIG. 2.

The electronic pen 2 can perform two-way communication with the electronic device 1. The electronic pen 2 includes, for example, a power supply 21, an information manager 22, a data manager 23, a sensor 24, a button 25, a pen controller 26, a communication module 261, electrodes 27 and 28, and an electrode switch 29. In the electronic pen 2, the button 25 and the electrodes 27 and 28 are provided on the surface of the housing, and the power supply 21, the information manager 22, the data manager 23, the sensor 24, the communication module 261, the electrode switch 29, and the pen controller 26 are provided in the housing.

The power supply 21 is any type of power supply, such as a battery that supplies power to the electronic pen 2 and a rechargeable power supply.

The information manager 22 stores pen function information of the electronic pen 2. The pen function information includes, for example, information related to predetermined functions of the electronic pen 2 and setting information related to the settings of the electronic pen 2 that can be adjusted by the user. The information manager 22 updates the setting information every time the user changes the settings of the electronic pen 2, such as the color of the electronic pen 2 and the line width of the electronic pen 2.

The data manager 23 manages operation data of the electronic pen 2. The operation data indicates the operation state of the electronic pen 2, such as the pressure at the tip of the electronic pen 2 and the rotation state and the battery level of the electronic pen 2. The operation data is generated by the sensor 24. The sensor 24 includes a pressure sensor configured to detect the pressure applied to the tip of the electronic pen 2 and a rotation sensor configured to detect the rotation of the electronic pen 2.

The pen controller 26 controls the operation of the communication module 261 and the electrode switch 29 in the two-way communication with the sensor controller 40 of the electronic device 1. Specifically, the pen controller 26 controls the electrode switch 29 to set the electrodes 27 and 28 to a transmission mode for transmitting the pen function information and the operation data to the sensor controller 40 through the communication module 261 and the electrode 27.

The communication module 261 is a module that performs two-way communication with the electronic device 1. The communication module 261 includes a transmission (TX) circuit and a reception (RX) circuit that communicate with the electronic device 1 through at least one of the electrodes 27 and 28. The electrodes 27 and 28 are used for communicating with the electrodes of the pen sensor 30 of the electronic pen 2.

The electrodes 27 and 28 are arranged at different positions on the housing of the electronic pen 2. Specifically, the electrode 27 is provided at the pen tip of the electronic pen 2. The electrode 27 is used to indicate the coordinate value of the electronic pen 2 on the display panel 10 and to communicate with the sensor controller 40. The electrode 28 is provided above the electrode 27 and below a holding unit to be held by the user holding the electronic pen 2. The electrode 28 is separated from the electrode 27. The electrode 28 is a ring electrode formed in an annular shape, and the electrode 28 is provided to cover the circumference of the electronic pen 2. The electrode 28 is used to measure the posture value of the electronic pen 2.

The electrode switch 29 is a switch for switching the operation of the electrodes 27 and 28 between the transmission mode and a reception mode.

### Functional Components

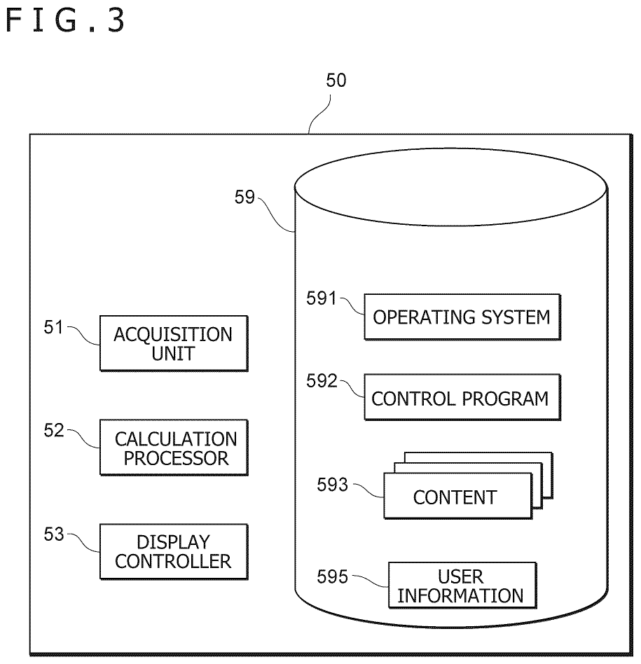

The functional components of the host processor 50 of the electronic device 1 will be described with reference to FIG. 3. FIG. 3 depicts an example of the functional components of the host processor 50 of the electronic device 1. As illustrated in FIG. 3, the host processor 50 includes functional components including, for example, an acquisition unit 51, a calculation processor 52, a display controller 53, and a storage unit 59. Note that the CPU of the host processor 50 executes programs stored in the storage apparatus or the like of the host processor 50 to realize the functional section other than the storage unit 59.

The acquisition unit 51 acquires user information 595 stored in the storage unit 59.

The calculation processor 52 calculates the rotation angle of the displayed object displayed on the display panel 10 on the basis of the detection information indicating the state related to the posture of the electronic pen 2 detected by the pen sensor 30 and reference information indicating a reference state related to the posture of the electronic pen 2. The detection information includes the pen coordinate value indicating the position of the electronic pen 2, the posture value indicating the posture of the electronic pen 2, and the contact part coordinate value indicating the position of the contact part 3. The detection information is detected by the pen sensor 30. The reference information includes a pen coordinate value indicating the position of the electronic pen 2, a posture value indicating the posture of the electronic pen 2, and a contact part coordinate value indicating the position of the contact part 3, as with the detection information. The reference information is stored in the storage unit 59.

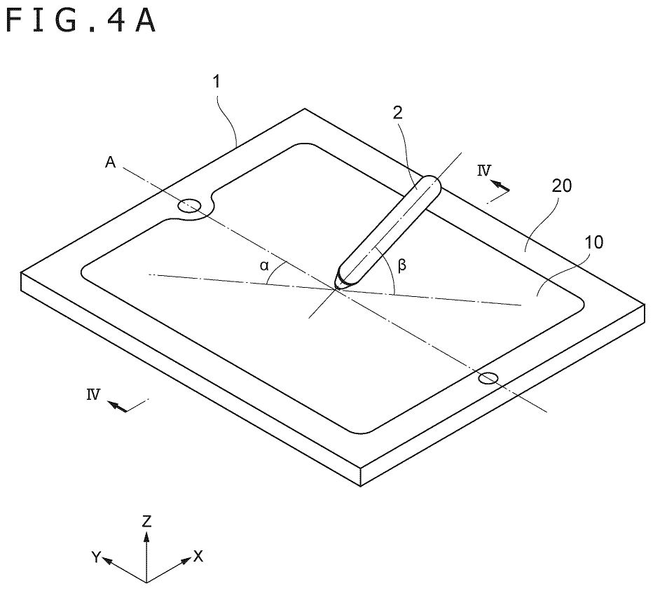

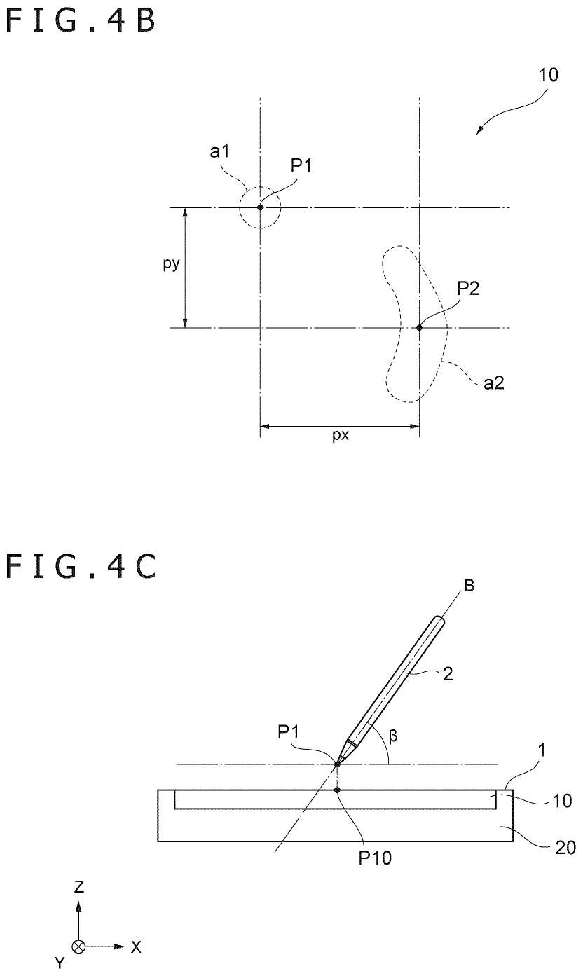

Here, the coordinate value, the posture value, and the contact part coordinate value will be described with reference to FIGS. 4A to 4C. FIG. 4A depicts the posture of the electronic pen 2 relative to the display panel 10 of the electronic device 1. In FIG. 4A, a virtual axis extending parallel to the Y-axis direction to pass through the position indicated by the electronic pen 2 on the display panel 10 will be referred to as an axis A. A virtual axis extending in the extension direction of the electronic pen 2 will be referred to as an axis B.

The posture value of the electronic pen 2 includes, for example, a tilt value indicating the tilt of the electronic pen 2 and an azimuth value indicating the azimuth of the electronic pen 2 on the display panel 10. The tilt value is an angle of the electronic pen 2 in the Z-axis direction relative to the plane of the front area of the display panel 10. Specifically, the tilt value is an angle β between the axis B and one of the X-axis and the Y-axis in the virtual plane formed by the X-axis and the Z-axis or by the Y-axis and the Z-axis.

The azimuth value is a value indicating the azimuth of the pen tip of the electronic pen 2 when the display panel 10 is viewed from the Z-axis direction. Specifically, the azimuth value is an angle between the axis A and a vector V of the pen tip in the virtual plane formed by the X-axis and the Y-axis.

FIG. 4B depicts a position of the electronic pen 2 and a position of the contact part 3 on the display panel 10. FIG. 4C is a cross-sectional view along line IV-IV of the electronic device 1 illustrated in FIG. 4A. The area a1 in FIG. 4B is an area indicated by the pen tip of the electronic pen 2 on display panel 10. A point P1 is a point with the highest signal level detected by the pen sensor 30 in the area a1. The area a2 is an area indicated by the contact part 3 on the display panel 10. A point P2 is a point with the highest signal level detected by the pen sensor 30 in the area a2. A distance px is a distance between the point P1 and the point P2 in the X-axis direction. A distance py is a distance between the point P1 and the point P2 in the Y-axis direction. In FIG. 4C, a point P10 is a projection point of the pen tip of the electronic pen 2 on the display panel 10.

The coordinate value is a value including the position in the X-axis direction, the position in the Y-axis direction, and the position in the Z-axis direction of each point in the area a1 including point P1 on the display panel 10. The contact part coordinate value is a value including the position in the X-axis direction, the position in the Y-axis direction, and the position in the Z-axis direction of each point in the area a2 including point P2 on the display panel 10.

FIG. 3 will be further described. The display controller 53 controls the display of the display panel 10 such that the displayed object is rotated by the rotation angle calculated by the calculation processor 52.

The storage unit 59 stores an operating system 591 for controlling the operation of the electronic device 1, a control program 592 for controlling the display of content 593, multiple pieces of content 593 that form displayed objects, and the user information 595. The storage unit 59 further stores various other values, information, and the like that need to be stored in advance in the electronic device 1.

The operating system 591 is system software for controlling various operations in the electronic device 1. The operating system 591 controls the control program 592 and the content 593 and controls the operations of the acquisition unit 51, the calculation processor 52, and the display controller 53. The operating system 591 also controls any displayed object displayed on the display panel 10.

The control program 592 is a program for controlling the display of the content 593 as displayed objects on the display panel 10. The control program 592 is used to comprehensively control the display of the content 593 on the display panel 10. The priority of the display control by the control program 592 is lower than the priority of the display control by the operating system 591. The display control by the operating system 591 is prioritized when different display control instructions are issued for the same displayed object.

The content 593 includes various applications, software, programs, games, image data, video data, tools, and the like supported by the electronic device 1, and the content 593 is displayed as displayed objects on the display panel 10. Note that the settings of the display control of the content 593 can be individually set. The priority of the display control by the content 593 is lower than the priority of the display control by the control program 592. The display control by the control program 592 is prioritized when different display control instructions are issued for the same displayed object.

The user information 595 is information related to the user. The user information 595 includes, for example, the user name, the log-in status indicating whether or not the user is logged in, and the reference information including the coordinate value, the posture value, and the contact part coordinate value. The reference information is information including reference ranges related to the posture value, the coordinate value, and the contact part coordinate value. The reference information is information indicating the positional relation between the coordinates of the electronic pen 2 and the coordinates of the contact part 3 as well as the posture of the electronic pen 2 at the time when the user holding the electronic pen 2 inputs data to the display panel 10. For example, the reference information is registered for each user through the execution of the setting mode. Multiple pieces of reference information may be registered for each user.

### Flow of Operations

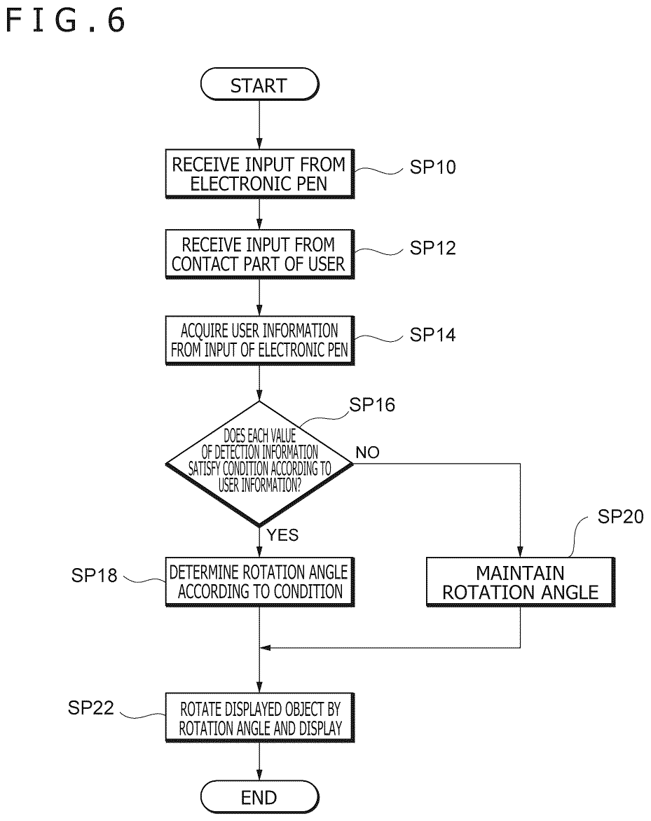

The configuration of the electronic device 1 has been described. Next, the transition of the potential of various signals in the electronic device 1 will be described in detail. FIG. 6 is a flow chart illustrating an example of a flow of processes executed by the electronic device 1.

### Step SP10

In the electronic device 1, the pen sensor 30 receives, from the electronic pen 2, an input of the detection information including the position and the posture of the electronic pen 2 and the information related to the user. The process moves to the process of step SP12.

### Step SP12

In the electronic device 1, the pen sensor 30 receives, from the contact part 3, an input of the detection information including the information related to the position of the contact part 3. The process moves to the process of step SP14.

### Step SP14

In the electronic device 1, the acquisition unit 51 acquires the information including the user information 595 transmitted from the electronic pen 2. The user information 595 includes at least the reference information. The electronic device 1 stores, in the storage unit 59, the user information 595 acquired by the acquisition unit 51. The process moves to the process of step SP16.

### Step SP16

In the electronic device 1, the calculation processor 52 determines whether or not each value of the detection information detected by the pen sensor 30 satisfies a predetermined condition in accordance with the user information 595. The predetermined condition includes, for example, a condition (hereinafter, an “individual condition”) related to at least one of the coordinate value, the azimuth value, the tilt value, and the contact part coordinate value of the detection information or a combination of a plurality of individual conditions. The predetermined condition is, for example, whether or not the coordinate value, the azimuth value, the tilt value, and the contact part coordinate value of the detection information are within the ranges of the coordinate value, the azimuth value, the tilt value, and the contact part coordinate value of the reference information, respectively. The predetermined condition may be that all of the coordinate value, the azimuth value, the tilt value, and the contact part coordinate value of the detection information are within the ranges of the values included in the reference information or may be that some of the values are within the ranges of the values included in the reference information. The process moves to the process of step SP18 if the determination is affirmative. On the other hand, the process moves to the process of step SP20 if the determination is negative.

### Step SP18

In the electronic device 1, the calculation processor 52 calculates, as a rotation angle, an angle in a direction associated with the predetermined condition relative to a reference direction which is set in advance on the display panel 10. The angle in the direction associated with the predetermined condition may be, for example, one of four angles including 0°, 90°, 180°, and −90° starting with the Y-axis direction as the reference direction and moving clockwise when the display panel 10 is viewed in the Z-axis direction. The number of angles in the directions associated with the predetermined conditions is not limited to four, which is an example, and may be any number of angles. The process moves to the process of step SP22.

### Step SP20

In the electronic device 1, the calculation processor 52 maintains the rotation angle instead of newly calculating the rotation angle. The process moves to the process of step SP22.

### Step SP22

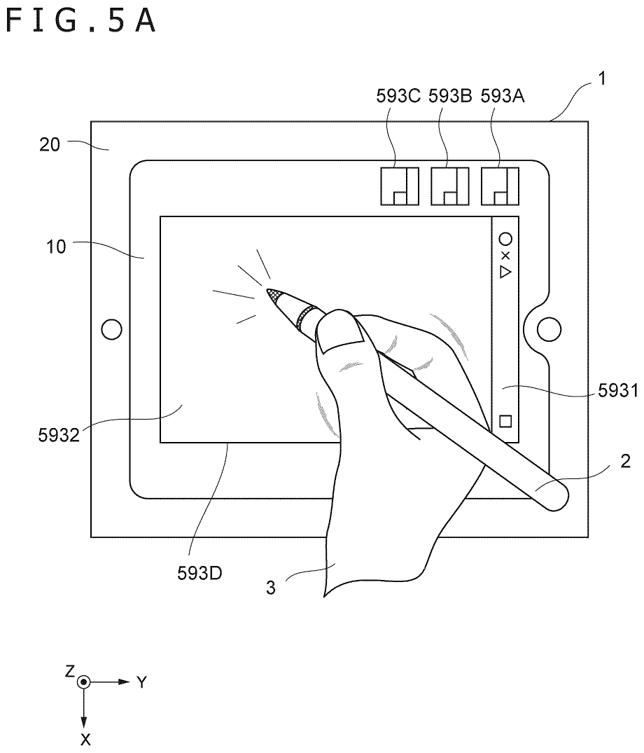

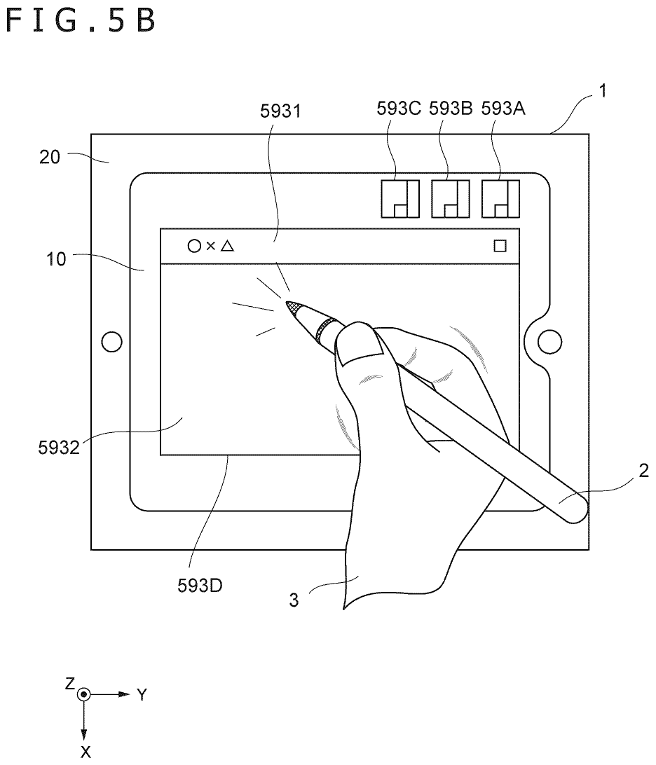

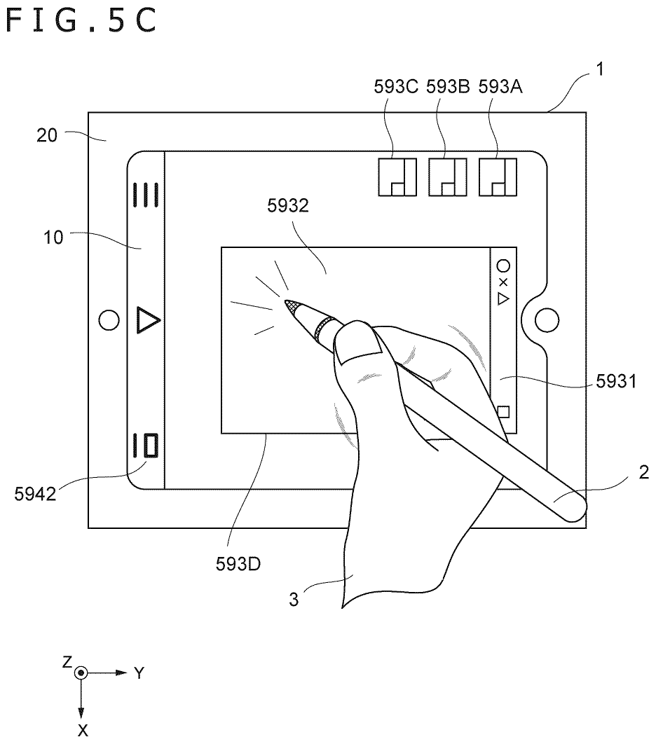

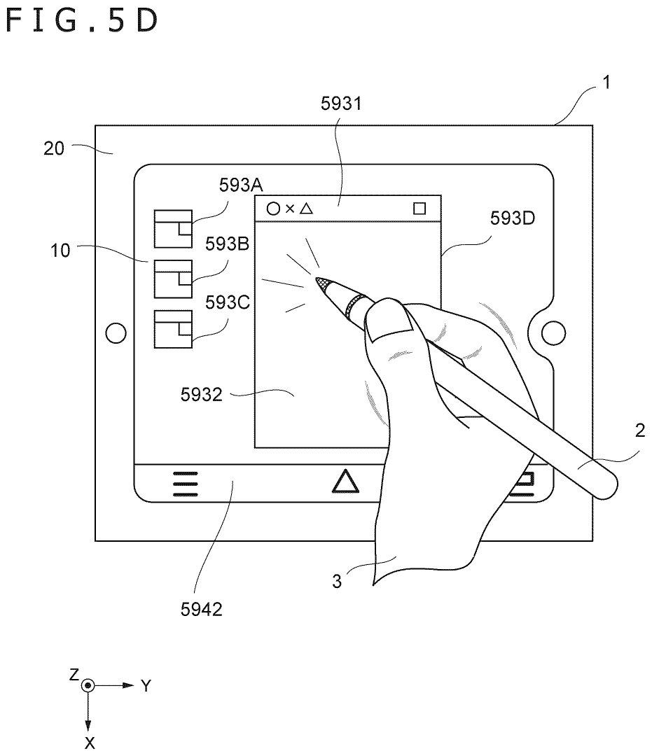

In the electronic device 1, the display controller 53 rotates the displayed objects by the rotation angle and controls the display of the displayed objects in the display area of the display panel 10. Here, the rotation angle and the display control of the displayed objects will be described with reference to FIGS. 5A and 5B. FIG. 5A depicts a first example of the electronic device 1 displaying the displayed objects before the rotation. FIG. 5B depicts a first example of the electronic device 1 displaying the displayed objects after the rotation. In FIG. 5A, the electronic pen 2 and the contact part 3 in the electronic device 1 are used to input data at an angle of 90° with respect to the Y-axis direction (e.g., the user's hand extends along the X-axis direction in FIG. 5A at an angle of 90° with respect to the Y-axis direction). In the electronic device 1, content 593A to content 593D are displayed on the display panel 10 at the rotation angle of 0° with respect to the Y-axis direction. The content 593A to content 593C are not yet activated (not yet launched) and displayed as icons in the display area of the display panel 10. The content 593D is activated (launched) and displayed in the display area of the display panel 10.

The content 593D is, for example, a drawing application, and the content 593D includes a content menu 5931 and a drawing area 5932. The content 593D renders (generates) a drawing according to drawing settings (a pen mode, filling mode, eraser mode, blurring mode, etc.) which are set in the content menu 5931 and according to the input in the drawing area 5932 made by the electronic pen 2 and the contact part 3. In FIG. 5A, the electronic device 1 detects, as detection information, that the data is input to the display panel 10 by the electronic pen 2 and the contact part 3. The electronic device 1 determines that each value of the detection information satisfies the condition that the data is input at an angle of 90° with respect to the Y-axis direction and calculates −90° as the rotation angle.

As illustrated in FIG. 5B, the electronic device 1, while maintaining the rotation angle of the content 593A to content 593C, determines that the content 593D is the displayed object and rotates the content 593D by −90° clockwise (i.e., 90° counter-clockwise) with reference to the Y-axis direction as the reference direction to display the rotated content 593D on the display panel 10. The flow of processes illustrated in FIG. 6 ends.

### Effects

In the present embodiment, the electronic device 1 includes the display panel 10 that displays the displayed object, and the pen sensor 30 that overlaps the display area of the display panel 10 and detects the position and the posture of the electronic pen 2. The electronic device 1 further includes the calculation processor 52 that calculates the rotation angle of the displayed object displayed on the display panel 10 on the basis of the detection information indicating the state related to the posture of the electronic pen 2 detected by the pen sensor 30 and the reference information indicating the reference state related to the posture of the electronic pen 2. The electronic device 1 further includes the display controller 53 that controls the display of the display panel 10 to rotate the displayed object by the rotation angle calculated by the calculation processor 52.

According to the configuration, the electronic device 1 calculates the rotation angle on the basis of the detection state detected by the pen sensor 30 and the predetermined reference state. Therefore, a gyro sensor or the like that detects the posture including the tilt and the azimuth of the electronic pen 2 does not have to be provided in the electronic pen 2. As a result, the electronic device 1 can rotate and display the displayed object without impairing usability of the electronic device.

In the present embodiment, the pen sensor 30 is a touch sensor that further detects the position of the contact part 3 of the user holding the electronic pen 2. Each of the detection information and the reference information includes the pen coordinate value indicating the position of the electronic pen 2, the posture value indicating the posture of the electronic pen 2, and the contact part coordinate value indicating the position of the contact part 3.

Hence, even when the pen sensor 30 is a touch sensor that can detect the electronic pen 2 and the contact part 3, the electronic device 1 can rotate and display the displayed object without impairing the intuitive operation by the user. The detection information includes not only the value related to the posture of the electronic pen 2, but also the values related to the position of the electronic pen 2 and the position of the contact part 3. Therefore, the electronic device 1 can rotate and display the displayed object at high accuracy without impairing the usability.

In the present embodiment, the calculation processor 52 calculates, as the rotation angle, the angle in the direction associated with the predetermined condition relative to the reference direction set in advance on the display panel 10 when the detection information satisfies the predetermined condition with respect to the reference information.

According to the configuration, the electronic device 1 calculates the rotation angle according to whether or not the predetermined condition is satisfied. Therefore, various conditions can be provided for the rotation of the displayed object according to the reference information and the predetermined condition. As a result, the electronic device 1 can rotate and display the displayed object according to various conditions without impairing the usability.

In the present embodiment, the electronic pen 2 is an active pen capable of storing the user information 595 that is information related to the user and that includes the predetermined condition. The pen sensor 30 receives the user information 595 transmitted from the electronic pen 2. The calculation processor 52 calculates the rotation angle according to the predetermined condition indicated in the user information 595 received by the pen sensor 30.

Therefore, even when the user operating the electronic device 1 is changed, the electronic device 1 can use the user information 595 transmitted from the electronic pen 2 held by the new user to rotate and display the displayed object at the rotation angle in accordance with the predetermined condition registered in advance for the (new) user.

In the present embodiment, the electronic device 1 further includes the storage unit 59 that stores the content to be displayed on the display panel 10. The calculation processor 52 calculates the rotation angle of the predetermined area included in the content displayed as the displayed object on the display panel 10.

Therefore, the electronic device 1 can set different rotation angles for the content in the predetermined area and for the content outside the predetermined area and display the entire content on the display panel 10, without impairing the usability.

### Modifications

Note that the present disclosure is not limited to the above embodiment. That is, those skilled in the art can modify the design of the embodiment, and the modified embodiment is also included in the scope of the present disclosure as long as the modified embodiment has the features of the present disclosure. In addition, the elements included in the embodiment and modifications described later can be combined if technically possible, and the combination is also included in the scope of the present disclosure as long as the combination has the features of the present disclosure.

For example, although the electronic device 1 rotates the content 593D as the displayed object and displays the rotated content 593D on the display panel 10 while maintaining the rotation angle of the content 593A to content 593C in the embodiment, the configuration is not limited to this. The electronic device 1 may, for example, rotate all of the pieces of content displayed on the display panel 10 and display the content.

Another example of the rotation angles and the display control of the displayed objects will be described with reference to FIGS. 5C and 5D. FIG. 5C depicts a second example of the electronic device 1 displaying the displayed objects before the rotation. FIG. 5D depicts a second example of the electronic device 1 displaying the displayed objects after the rotation.

In FIG. 5C, the electronic pen 2 and the contact part 3 are used to input data at an angle of 90° with respect to the Y-axis direction in the electronic device 1 (e.g., the user's hand extends along the X-axis direction in FIG. 5C at an angle of 90° with respect to the Y-axis direction). A menu 5942 for various settings and operations of the operating system 591 is displayed on the opposite side of the Y-axis direction (i.e., in the minus direction on the Y-axis) in the display area in the electronic device 1. Note that the content 593A to content 593D on the display panel 10 are similar to those of FIG. 5A, and the description will not be repeated.

In FIG. 5C, the electronic device 1 detects, as detection information, that the data is input by the electronic pen 2 and the contact part 3 on the display panel 10. The electronic device 1 determines that each value of the detection information satisfies the condition that the data is input at an angle of 90° with respect to the Y-axis direction and calculates −90° as the rotation angle. As illustrated in FIG. 5D, the display controller 53 in the electronic device 1 follows the control instruction of the operating system 591 to determine that all of the objects displayed on the display panel 10 are the displayed objects. In the electronic device 1, the display controller 53 rotates all of the objects by −90° clockwise (i.e., 90° counter-clockwise) with respect to the Y-axis direction as the reference direction and controls the display of the objects on the display panel 10.

According to the configuration, the electronic device 1 sets, as displayed objects, all of the objects displayed on the display panel 10, and therefore it is not necessary to configure a detailed setting for each content 593 separately. The electronic device 1 can rotate and display the displayed objects in a simple process, without impairing the usability.

In the embodiment, although the predetermined condition related to the rotation angle is set in advance in the user information 595 for each of the content 593A to content 593D in the electronic device 1, the configuration is not limited to this. In the electronic device 1, the control program 592 may uniformly set in advance, in the user information 595, the predetermined condition related to the rotation angle of the content 593A to content 593D.

According to the configuration, the electronic device 1 calculates the rotation angle without the control by the operating system 591 and without the necessity for the detailed settings of each content 593. Therefore, the electronic device 1 can easily rotate and display the displayed objects while maintaining the flexibility of the settings, without impairing the usability.

In the embodiment, although the acquisition unit 51 of the electronic device 1 acquires the user information 595 including the predetermined condition transmitted from the electronic pen 2 and stores the user information 595 in the storage unit 59, the configuration is not limited to this. In the electronic device 1, the user information 595 related to the user may be stored in advance in the storage unit 59. In the electronic device 1, the storage unit 59 stores, for each user, the user information 595 including the log-in status of the user and the predetermined condition associated with the user. In the electronic device 1, the acquisition unit 51 acquires the user information 595 from the storage unit 59. The calculation processor 52 of the electronic device 1 calculates the rotation angle according to the predetermined condition indicated by the user information 595 associated with the currently logged-in user.

According to the configuration, the electronic device 1 calculates the rotation angle according to the predetermined condition indicated by the user information 595 set in advance in the storage unit 59. Therefore, even when multiple persons share the electronic device 1, the displayed object can be rotated and displayed (for the currently logged-in user) without impairing the usability.

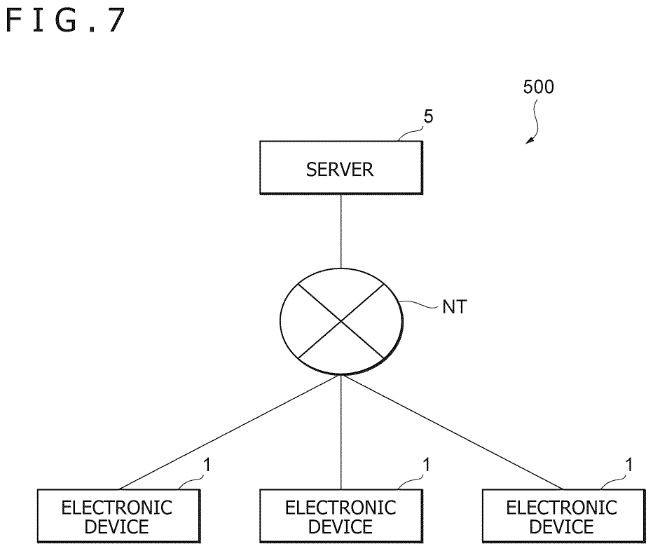

In the electronic device 1, the acquisition unit 51 may acquire the user information 595 stored in an external server apparatus through a communication network NT. The server apparatus will be described with reference to FIG. 7. FIG. 7 is a schematic view illustrating a configuration of a communication system 500 including the electronic device 1 and a server 5. In the communication system 500, a plurality of electronic devices 1 and the server 5 are connected through the communication network NT.

The server 5 stores various types of data used for executing various applications stored in the electronic device 1 and the user information 595 related to the user of the electronic device 1. The server 5 includes, for example, a communication apparatus, a storage apparatus, a CPU, and a memory. The server 5 functions as various functional components, to be described later, when the CPU executes predetermined programs stored in the memory, the storage apparatus, or the like. The communication apparatus includes a communication interface or the like for communicating with an external apparatus. The storage apparatus includes a hard disk or the like. The storage apparatus stores various programs and various types of information necessary for executing the processes in the server 5 and stores information of processing results.

The server 5 communicates with the electronic device 1 through the communication network NT. The server 5 transmits, to the electronic device 1, the user information 595 including the log-in status of the user and the predetermined condition associated with the user, in response to the request from the electronic device 1.

In the electronic device 1, the acquisition unit 51 acquires the user information 595 from the external server 5. The calculation processor 52 calculates the rotation angle according to the user information 595 associated with the currently logged-in user acquired by the acquisition unit 51.

According to the configuration, the electronic device 1 acquires the user information 595 stored in the server 5. Therefore, even when multiple persons share the electronic device 1 or the electronic pen 2, the displayed object can be rotated and displayed (for the currently logged-in user) without impairing the usability.

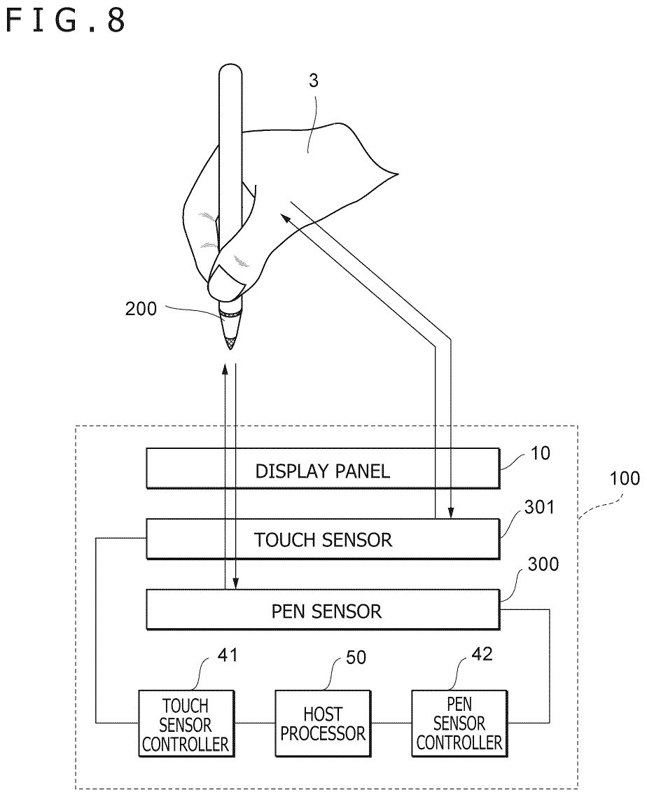

Although the pen sensor 30 is a touch sensor in the present embodiment, the pen sensor 30 is not limited to this. The pen sensor 30 may be formed of, for example, a loop coil antenna used in the EMR type system. The electronic device 1 may further include a touch sensor in addition to the pen sensor 30 that is formed of a loop coil antenna. The case in which the pen sensor 30 is a loop coil antenna will be described with reference to FIG. 8.

FIG. 8 depicts another example of specific configurations of the electronic device 1 and the electronic pen 2. As illustrated in FIG. 8, an electronic device 100 includes the display panel 10, a touch sensor 301, a pen sensor 300, a touch sensor controller 41, a pen sensor controller 42, and the host processor 50. Note that the host processor 50 and the display panel 10 are similar to those of the electronic device 1, and the description will not be repeated.

An electronic pen 200 is a stylus including a resonant circuit used in the EMR type system. The electronic pen 200 receives a magnetic field generated by the pen sensor 300 and drives the resonant circuit according to the received magnetic field.

The touch sensor 301 is similar to the pen sensor 30 and is, for example, a capacitance sensor including a plurality of detection electrodes arranged in a planar shape. The touch sensor 301 detects the indicated position of the contact part 3 of the user. Although the touch sensor 301 is an “external” sensor attached from the outside to the display panel 10 in the present embodiment, the touch sensor 301 is not limited to this. The touch sensor 301 may be a “built-in” (in more detailed classification, “on-cell” or “in-cell”) sensor integrated with the display panel 10.

The touch sensor controller 41 controls the operation of the position detection of a passive pointer, such as the contact part 3 of the user, performed by the touch sensor 301. The touch sensor controller 41 also communicates with the host processor 50. Specifically, the touch sensor controller 41 processes handwritten input data from the touch sensor 301 and detects, as a contact part coordinate value, the position on the touch sensor controller 41 indicated by the contact part 3. The touch sensor controller 41 transfers, as detection information, the detected contact part coordinate value to the host processor 50.

The pen sensor 300 is formed of a loop coil antenna used in the EMR type system. The pen sensor 300 generates the magnetic field from the coil antenna and receives a response from the resonant circuit included in the electronic pen 200, to detect the indicated position of the electronic pen 200. Note that part or all of the pen sensor 300 may be incorporated into another member such as the touch sensor 301. For example, of the pen sensor 300, a transmission coil (or a power coil) may be integrated with a light source board of the display panel 10, and a detection coil may be integrated with the touch sensor 301.

The pen sensor controller 42 controls the operation of the position detection of the electronic pen 200 performed by the pen sensor 300. The pen sensor controller 42 also communicates with the host processor 50. Specifically, the pen sensor controller 42 processes the handwritten input data from the pen sensor 30. The pen sensor controller 42 detects, as a coordinate value, the position on the pen sensor controller 42 indicated by the electronic pen 2 and detects, as a posture value, the posture of the electronic pen 2. The pen sensor controller 42 transfers the detected coordinate value, posture value, and contact part coordinate value as detection information to the host processor 50.

According to the configuration, the electronic device 100 includes the EMR pen sensor 300 that detects the position and the posture of the electronic pen 200, and the capacitance touch sensor 301 that detects the contact part 3. Therefore, even when the electronic pen 2 is an EMR stylus, the electronic device 100 can rotate and display the displayed object without impairing the usability of the electronic device.

Although the predetermined condition is whether or not each value of the detection information is within each range of the reference information in the present embodiment, the predetermined condition is not limited to this. The predetermined condition may be, for example, that, after rotating each of the coordinate value, the contact part coordinate value, and the azimuth value of the detection information by a unit angle while using the center point of the display panel 10 as a reference point, whether or not the resulting values (after the rotation) are within ranges associated with the coordinate value, the contact part coordinate value, and the azimuth value of the reference information.

According to the configuration, the predetermined condition does not have to be provided for each rotation angle. Therefore, the electronic device 1 can rotate and display the displayed object with a small number of setting items, without impairing the usability.

1. An electronic device, comprising:
a display panel configured to display a displayed object;
a pen sensor provided to overlap a display area of the display panel and configured to detect a position and a posture of the electronic pen;
a calculation processor configured to calculate a rotation angle of the displayed object displayed on the display panel on a basis of detection information indicating a state related to the posture of the electronic pen detected by the pen sensor and on a basis of reference information indicating a reference state related to the posture of the electronic pen; and
a display controller configured to control display of the display panel to rotate the displayed object by the rotation angle calculated by the calculation processor.

2. The electronic device according to claim 1, wherein
the pen sensor is a touch sensor that detects a position of a contact part of a user holding the electronic pen, and
each of the detection information and the reference information includes a pen coordinate value indicating a position of the electronic pen, a posture value indicating a posture of the electronic pen, and a contact part coordinate value indicating a position of the contact part.

3. The electronic device according to claim 1, comprising:
a touch sensor provided to overlap the display area and the pen sensor and configured to detect a position of a contact part of a user holding the electronic pen, wherein
each of the detection information and the reference information includes a pen coordinate value indicating a position of the electronic pen, a posture value indicating a posture of the electronic pen, and a contact part coordinate value indicating a position of the contact part.

4. The electronic device according to claim 1, wherein
when the detection information satisfies a predetermined condition with respect to the reference information, the calculation processor calculates, as the rotation angle, an angle in a direction associated with the predetermined condition relative to a reference direction set in advance on the display panel.

5. The electronic device according to claim 4, wherein
the electronic pen is an active pen capable of storing user information that is information related to a user and that includes the predetermined condition,
the pen sensor receives the user information transmitted from the electronic pen, and
the calculation processor calculates the rotation angle according to the predetermined condition indicated in the user information received by the pen sensor.

6. The electronic device according to claim 4, comprising:
a storage unit that stores, for each user, user information including a log-in status of a user and the predetermined condition associated with the user, wherein
the calculation processor calculates the rotation angle according to the predetermined condition indicated in the user information associated with the currently logged-in user.

7. The electronic device according to claim 4, comprising:
an acquisition unit that acquires, from an external server, user information including a log-in status of a user and the predetermined condition associated with the user, wherein
the calculation processor calculates the rotation angle according to the user information associated with the currently logged-in user.

8. The electronic device according to claim 1, wherein
the displayed object includes all objects displayed on the display panel.

9. The electronic device according to claim 1, comprising:
a storage unit that stores content to be displayed on the display panel, wherein
the calculation processor calculates the rotation angle of the content as the displayed object on the display panel.

10. The electronic device according to claim 1, comprising:
a storage unit that stores content to be displayed on the display panel, wherein
the calculation processor calculates the rotation angle of a predetermined area included in the content as the displayed object on the display panel.

11. A program stored in a non-transitory computer-readable medium, which, when executed by a computer, causes the computer to perform processing as:
a calculation processor of an electronic device having a display panel that displays a displayed object and a pen sensor provided to overlap a display area of the display panel, wherein the pen sensor is configured to detect a position and a posture of the electronic pen, wherein the calculation processor is configured to calculate a rotation angle of the displayed object displayed on the display panel on a basis of detection information indicating a state related to the posture of the electronic pen detected by the electronic pen and on a basis of reference information indicating a reference state related to the posture of the electronic pen; and
a display controller configured to control display of the display panel to rotate the displayed object by the rotation angle calculated by the calculation processor.

12. An input system, comprising:
an electronic pen configured to indicate a position to a display panel configured to display a displayed object; and
an electronic device including:
a pen sensor provided to overlap a display area of the display panel and configured to detect a position and a posture of the electronic pen;
a calculation processor configured to calculate a rotation angle of the displayed object displayed on the display panel on a basis of detection information indicating a state related to the posture of the electronic pen detected by the pen sensor and on a basis of reference information indicating a reference state related to the posture of the electronic pen; and
a display controller configured to control display of the display panel to rotate the displayed object by the rotation angle calculated by the calculation processor.
